(19) United States
(12) Patent Application Publication
(10) Pub. No.: US 2026/0316291 A1
(43) Pub. Date: Oct. 15, 2026

(54) ROBOT FOOT STRUCTURE AND ROBOT

(71) Applicant: Sony Interactive Entertainment Inc., Tokyo (JP)

(72) Inventors: Kazuya Kikuchi, Tokyo (JP); Hiroshi Osawa, Kanagawa (JP)

(21) Appl. No.: 19/684,490

(22) Filed: May 21, 2026

Related U.S. Application Data
(63) Continuation of application No. PCT/JP2024/040152, filed on Nov. 12, 2024.

(30) Foreign Application Priority Data
Nov. 24, 2023 (JP) 2023-199257

(51) Int. Cl. B25J 13/08; B25J 11/00; B62D 57/032; G01L 5/00

(52) U.S. Cl. CPC B25J 13/085; B25J 11/00; B62D 57/032; G01L 5/0061

(57) ABSTRACT

A foot structure and a robot including the foot structure are disclosed. An example foot structure includes constraints and simply detects reaction force from a walking surface, as well as an example robot equipped therewith. A foot part of a robot includes a first sole member arranged at a back of the foot part, a second sole member arranged at a front of the first sole member, a joint mechanism that includes a movable member fitted with the second sole member and configured to move relative to the first sole member, a first sensor arranged on the first sole member to detect reaction force from a walking surface, and a second sensor arranged on the second sole member to detect reaction force from the walking surface.

This application is a continuation of International Patent Application No. PCT/JP2024/040152, filed on Nov. 12, 2024, which claims priority to Japanese Patent Application No. 2023-199257, filed on Nov. 24, 2023, the entire disclosure of which is incorporated herein by reference for all purposes.

### TECHNICAL FIELD

The present disclosure relates to a robot foot structure and a robot.

### BACKGROUND

Legged robots that walk by moving their leg parts are being developed. These robots may have their foot parts equipped with sensors that sense reaction force from a walking surface such as a floor or a ground in contact with the foot parts. Such sensors make it possible to calculate a gravity center position of the robot to control a robot's posture appropriately relative to the walking surface.

For example, WO/2021/079847 discloses that a strain-generating body subject to bending deformation is arranged between an instep member connected to the robot leg part and a sole member contacting the walking surface and that the reaction force from the walking surface is detected by multiple strain sensors arranged on the strain-generating body. For example, WO/2021/079848 also cited below discloses that the reaction force from the walking surface is detected by use of an elastic body with its fulcrum on either the instep member or the sole member to press a force sensor arranged on the other member.

### SUMMARY

According to foot structures described in WO/2021/079847 and WO/2021/079848 cited above, a sole member is formed by a single plate. This puts constraints on a movement of a robot's sole.

An object of the present disclosure is to provide a robot foot structure designed to enhance a degree of freedom of sole movement while appropriately detecting reaction force from a walking surface, and a robot equipped therewith.

The foot structure according to the present disclosure may be a foot structure provided on a bottom end of a robot leg part. The foot structure may include a first sole member arranged at a back of the foot structure and contacting a walking surface, a second sole member arranged at a front of the first sole member and contacting the walking surface, a joint mechanism that includes a movable member fitted with the second sole member and configured to move relative to the first sole member, a first sensor arranged on the first sole member to detect reaction force from the walking surface with respect to the first sole member, and a second sensor arranged on the second sole member to detect reaction force from the walking surface with respect to the second sole member. This configuration enhances the degree of freedom of the sole movement and enables appropriate detection of the reaction force from the walking surface.

The robot according to the present disclosure may be a robot having a leg part and a foot structure provided on a bottom end of the leg part. The robot may include a first sole member arranged at a back of the foot structure and contacting a walking surface, a second sole member arranged at a front of the first sole member and contacting the walking surface, a joint mechanism that includes a movable member fitted with the second sole member and configured to move relative to the first sole member, a first sensor arranged on the first sole member to detect reaction force from the walking surface with respect to the first sole member, and a second sensor arranged on the second sole member to detect reaction force from the walking surface with respect to the second sole member. This configuration enhances the degree of freedom of the sole movement and enables appropriate detection of the reaction force from the walking surface.

### BRIEF DESCRIPTION OF DRAWINGS

FIG. 1 is a schematic view depicting a layout of actuators mounted on a robot proposed by the present disclosure.

FIG. 2A is a perspective view depicting an upper side of a foot part of the robot.

FIG. 2B is a perspective view depicting a lower side of the foot part of the robot.

FIG. 2C is a plan view depicting the foot part of the robot.

FIG. 2D is a side view depicting the foot part of the robot.

FIG. 3 is a sectional view depicting a cross section of the foot part taken on line III-III in FIG. 2D.

FIG. 4 is a sectional view depicting a cross section of the foot part taken on line IV-IV in FIG. 2D.

FIG. 5 is a side view depicting a state in which a second sole member has moved from its position indicated in FIG. 2D.

FIG. 6 is a sectional view depicting a cross section of the foot part taken on line VI-VI in FIG. 4.

FIG. 7 is a sectional view depicting a cross section of the foot part in a state in which the second sole member is in a second posture.

FIG. 8 is a schematic view depicting exemplary electronic components mounted on a circuit board of the foot part.

### DETAILED DESCRIPTION

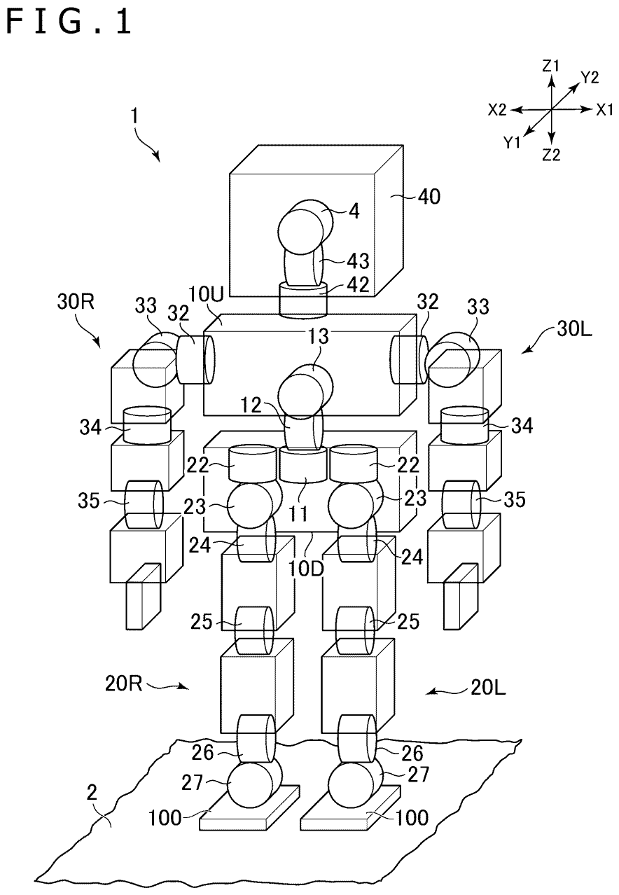

An embodiment of the present disclosure is described below with reference to the accompanying drawings. FIG. 1 is a schematic view depicting a layout of actuators mounted on a robot 1 proposed by the present disclosure. In the description that follows, it is assumed that a direction X1 and a direction X2 of an X axis indicated in FIG. 1 and elsewhere stand for a left side and a right side, respectively. It is also assumed that a direction Y1 and a direction Y2 of a Y axis perpendicular to the X axis in FIG. 1 and elsewhere stand for the front side and the back side, respectively. It is further assumed that a direction Z1 and a direction Z2 of a Z axis perpendicular to the X and Y axes in FIG. 1 and elsewhere stand for the upper side and the lower side, respectively. However, these directions and arrangement positions are prescribed solely to explain the shapes of and a relative positional relation between the elements (components, members, and parts) of the robot 1 and are not limitative of the postures and orientation of the robot 1.

The robot 1 is, for example, a humanoid robot capable of bipedal walking. As depicted in FIG. 1, the robot 1 may have a chest part 10U, a hip part 10D, and actuators 11 through 13 corresponding to a waist joint that moves the chest part with respect to the hip part 10D. The robot 1 may further have a right leg part 20R, a left leg part 20L, and multiple actuators that move these leg parts 20R and 20L. The right leg part 20R and the left leg part 20L may each have actuators 26 and 27 corresponding to an ankle joint, an actuator 25 corresponding to a knee joint, and actuators 22 through 24 corresponding to a hip joint. The robot 1 may also have a right arm part 30R, a left arm part 30L, and multiple actuators that move these arm parts 30R and 30L. The arm parts 30R and 30L may each have an actuator 35 corresponding to an elbow joint, an actuator 34 arranged on an upper arm, and actuators 32 and 33 corresponding to a shoulder joint. The robot 1 may also have a head part 40 and multiple actuators 42 through 44 corresponding to a neck joint that moves the head part 40.

The three actuators 11 through 13 corresponding to the waist joint of the robot 1 may rotate on a Z axis direction, an X axis direction, and a Y axis direction, respectively. This allows the chest part 10U of the robot 1 to change its angle on three axes, i.e., roll, pitch, and yaw, with respect to the hip part 10D. The three actuators 42 through 44 corresponding to the neck joint of the robot 1 may also rotate on the Z axis direction, the X axis direction, and the Y axis direction, respectively. This allows the head part 40 of the robot 1 to change its angle on the three axes of roll, pitch, and yaw with respect to the chest part 10U.

The layout of the actuators on the robot 1 is not limited to what is depicted in FIG. 1. For example, the actuators mounted on the robot 1 may be more or fewer than those indicated in FIG. 1. Moreover, the robot 1 may not be equipped with the head part 40, chest part 10U, and arm parts 30R and 30L. Further, the robot 1 may not be a humanoid robot depicted in FIG. 1 but a quadruped robot capable of walking that mimics animals such as dogs and cats. In this case, the robot 1 may have four legs, i.e., right and left front legs and right and left hind legs.

As depicted in FIG. 1, the leg parts 20R and 20L of the robot 1 may each have, on its bottom end, a foot part 100 (foot structure) that contacts a walking surface 2 such as a desktop, a floor, or a ground. The foot part 100 may be connected to the actuator 27 corresponding to the ankle joint of the leg part 20R or 20L. The actuators 26 and 27 for the leg parts 20R and 20L may be configured to rotate on the X axis direction and the Y axis direction, respectively. This allows the foot part 100 of each of the leg parts 20R and 20L to change its roll and pitch angles. Further, the actuators 24 through 27 provided on each of the leg parts 20R and 20L and moving at appropriate angles enable the robot 1 to walk on the walking surface 2. The walking surface 2 is not limited to flat surfaces and may also have unevenness and level differences.

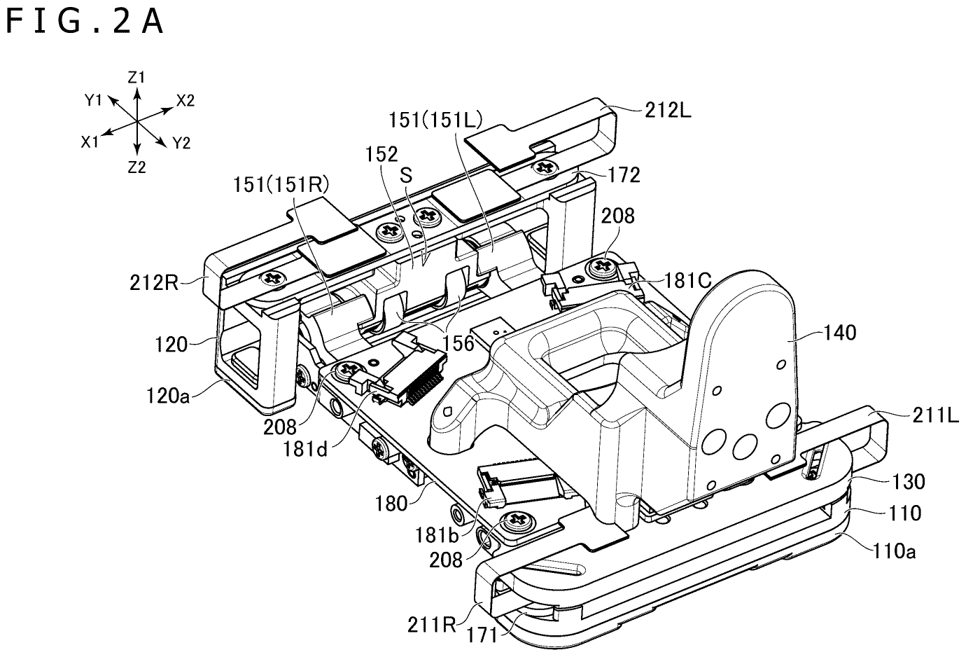

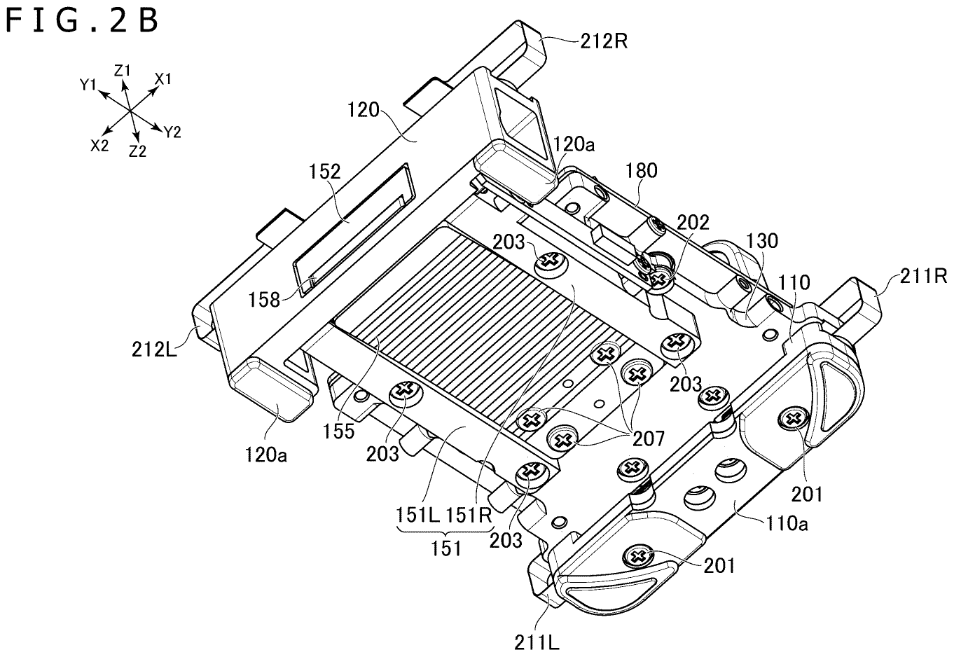

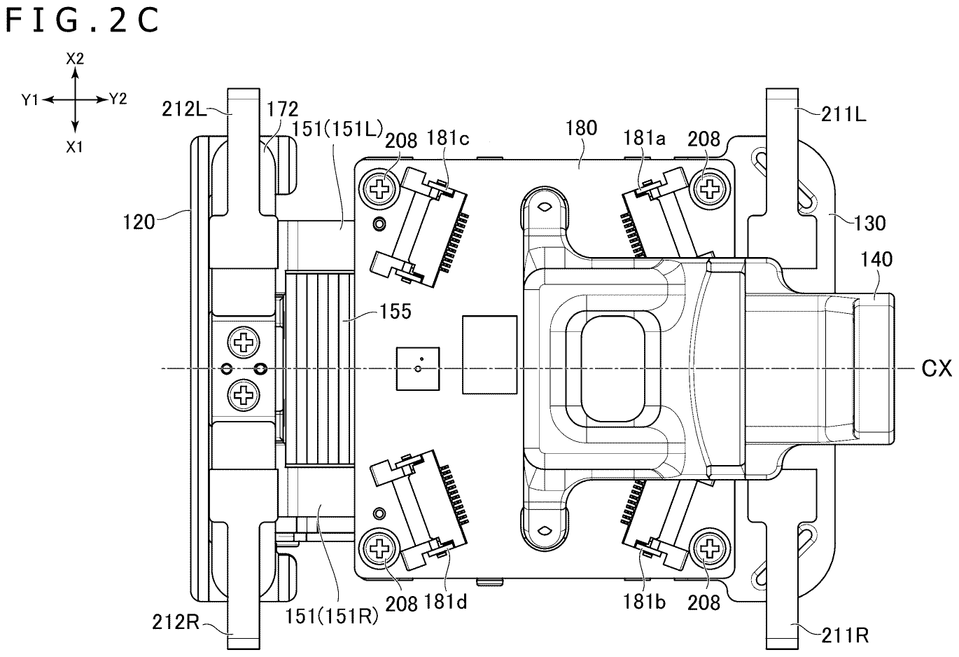

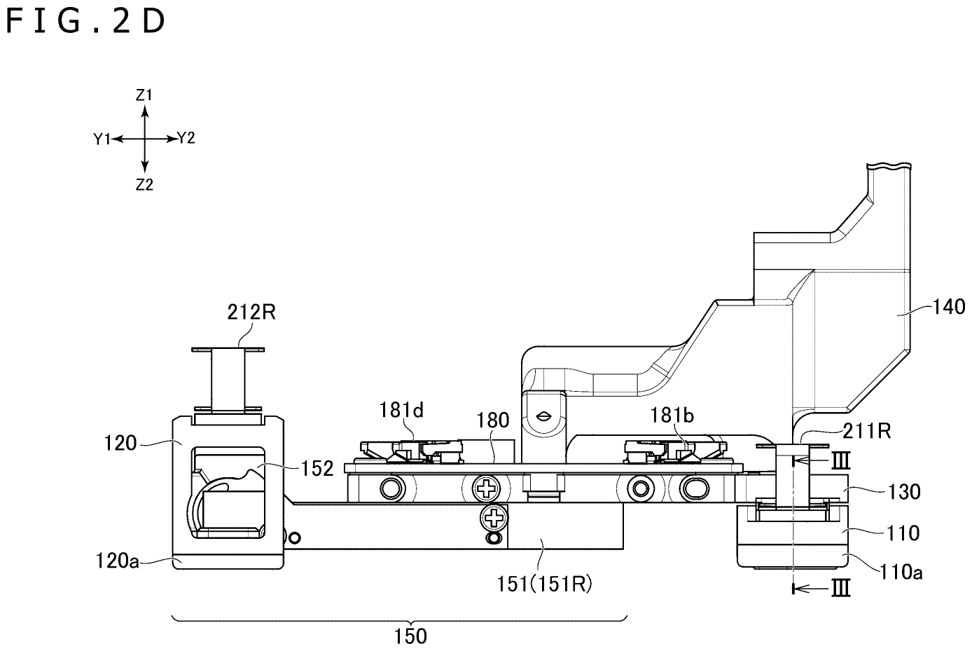

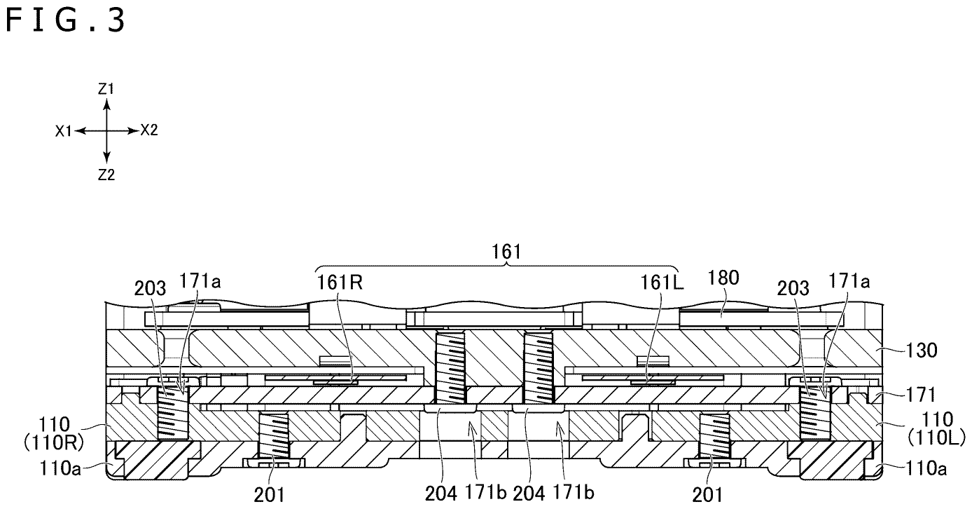

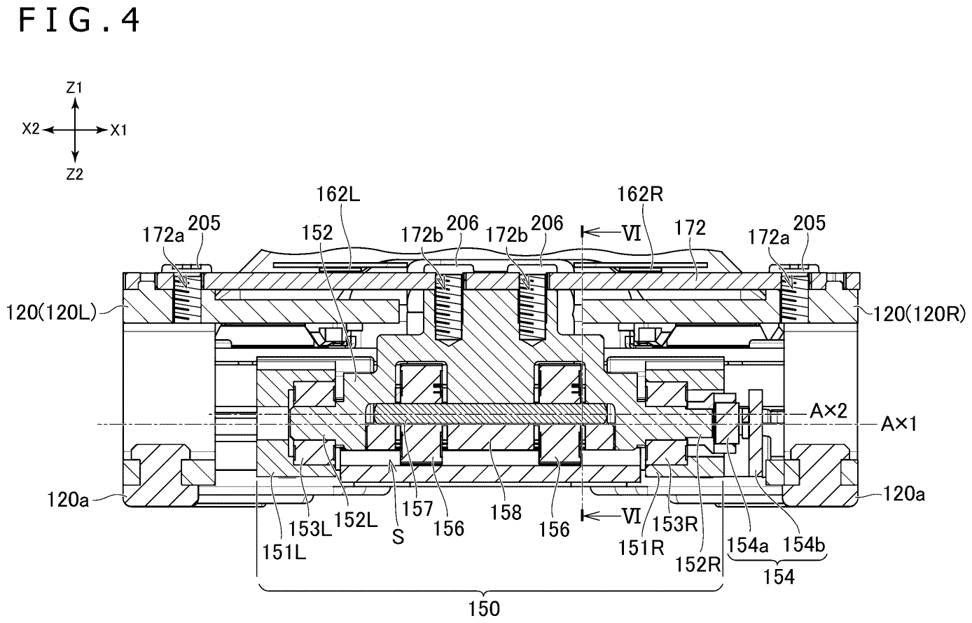

FIG. 2A is a perspective view depicting the upper side of the foot part 100 of the robot 1. FIG. 2B is a perspective view depicting the lower side of the foot part 100 of the robot 1. FIG. 2C is a plan view depicting the foot part 100 of the robot 1. FIG. 2D is a side view depicting the foot part 100 of the robot 1. FIG. 3 is a sectional view depicting a cross section of the foot part 100 taken on line III-III in FIG. 2D. FIG. 4 is a sectional view depicting a cross section of the foot part 100 taken on line IV-IV in FIG. 2D.

As depicted in FIG. 2A, the foot part 100 may be equipped with a first sole member 110 and a second sole member 120, the first sole member 110 being arranged at the back of the foot part 100 and contacting the walking surface 2 (see FIG. 1), the second sole member 120 being arranged at the front of the first sole member 110 and contacting the walking surface 2. In the foot part 100, the first sole member 110 may be a part corresponding to the heel, and the second sole member 120 may be a part corresponding to the toe. The first sole member 110 and the second sole member 120 may each be formed by metal such as iron or aluminum, resin, a rubber material, or an elastomer.

In a case where the first sole member 110 is formed by metal or resin, the bottom part of the first sole member 110 may be equipped with an anti-slip member 110a as depicted in FIG. 2B. The anti-slip member 110a may be formed at least partially by a rubber material or an elastomer. The anti-slip member 110a may be attached to the first sole member 110 by fixing implements 201 such as screws. Likewise, the bottom part of the second sole member 120 may be equipped with an anti-slip member 120a formed by a rubber material or an elastomer. As depicted in FIG. 3, the anti-slip member 120a may be attached to the second sole member 120 with a flange-shaped protruding part fitted into a hole formed in the second sole member 120. Alternatively, the anti-slip members 110a and 120a may be pasted by means of an adhesive agent.

As depicted in FIG. 2A, the foot part 100 may be equipped with an instep member 130 arranged at the top of the first sole member 110. The instep member 130 may be formed by metal or resin. The instep member 130 may be connected to the leg part 20R or 20L (see FIG. 1). The instep member 130 may be interposed, in an up-down direction, between the leg part 20R or 20L and the first sole member 110.

As depicted in FIG. 2A, a circuit board 180 may be mounted on the upper part of the instep member 130. The circuit board 180 may be fixed to the instep member 130 by use of multiple fixing implements 208 such as screws (see FIG. 2C). Further, the upper part of the instep member 130 may be equipped with a connecting member 140. The connecting member 140 may be formed by metal or resin. The connecting member 140 may be fixed to the instep member 130 by multiple fixing implements 202 such as screws (see FIG. 2B).

The instep member 130 may be connected to the actuator 27 of the leg part 20R or 20L via the connecting member 140. Alternatively, the instep member 130 may be connected directly to the actuator 27 of the leg part 20R or 20L without using intervening parts such as the connecting member 140. The instep member 130 and the connecting member 140 may be formed by metal such as iron or aluminum or by resin.

As depicted in FIG. 2D, the foot part 100 may include a joint mechanism 150 that functions as the joint of the foot part 100. The joint mechanism 150 may have a frame 151 extending in a front-back direction in front of the first sole member 110, and a movable member 152 provided at the front end of the frame 151. The frame 151 may be formed by metal or resin. The frame 151 may include a left frame 151L (see FIG. 2B) extending in the front-back direction at a position offset to the left of a center line CX (see FIG. 2C) of the foot part 100 in a right-left direction, and a right frame 151R (see FIG. 2B) extending in the front-back direction at a position offset to the right of the center line CX. The frame 151 may be attached to the bottom side of the instep member 130 by fixing implements 203 such as screws.

As depicted in FIGS. 2A and 4, there may be a space inside the frame 151 (e.g., between the left frame 151L and the right frame 151R). The movable member 152 may be arranged at least partially in this space. The movable member 152 may be formed by metal or resin. The second sole member 120 may be attached to the movable member 152. As will be discussed later, the movable member 152 may be configured to move relative to the first sole member 110 and to the instep member 130. This enables the second sole member 120 attached to the movable member 152 to move relative to the first sole member 110 and to the instep member 130.

As depicted in FIG. 3, the first sole member 110 may be equipped with a first sensor 161 that detects the reaction force from the walking surface 2 with respect to the first sole member 110. This enables the first sole member 110 disposed at the back of the foot part 100 (e.g., a portion corresponding to the heel) to detect the reaction force from the walking surface 2.

Further, as depicted in FIG. 4, the second sole member 120 may be equipped with a second sensor 162 that detects the reaction force from the walking surface 2 with respect to the second sole member 120. This enables the second sole member 120 arranged at the front of the foot part 100 (e.g., a portion corresponding to the toe) to detect the reaction force from the walking surface 2.

As described above, when attached to the movable member 152, the second sole member 120 can move relative to the first sole member 110. This makes a degree of freedom of the sole movement higher than if the sole member is formed by a single plate, for example. Further, the first sole member 110 and the second sole member 120 are equipped with the sensors 161 and 162 that detect the reaction force from the walking surface 2. Upon walking on the walking surface 2 having unevenness and level differences, for example, these sensors make it possible appropriately to detect both the reaction force acting on the first sole member 110 and the reaction force acting on the second sole member 120.

The first sole member 110 may be configured to tilt to the right and left with respect to the instep member 130 upon stepping on the walking surface 2 having unevenness and level differences, for example. In the example in FIG. 3, either a left end 110L or a right end 110R of the first sole member 110 may be configured to move in the up-down direction with respect to the other end. Here, the first sensor 161 arranged on the first sole member 110 may include sensors 161L and 161R, the sensor 161L being arranged at a position offset to the left of the center line CX (see FIG. 2C) of the foot part 100 in the right-left direction, the sensor 161R being arranged at a position offset to the right of the center line CX. When both the sensor 161L and the sensor 161R detect the reaction force from the walking surface 2, it is possible to identify whether the reaction force from the walking surface 2 is larger on the left side of the first sole member 110 or on the right side thereof.

The second sole member 120 may also be configured to tilt to the right and left with respect to the movable member 152 upon stepping on the walking surface 2 having unevenness and level differences. In the example in FIG. 4, either a left end 120L or a right end 120R of the second sole member 120 may be configured to move in the up-down direction with respect to the other end. Here, the second sensor 162 arranged on the second sole member 120 may also include sensors 162L and 162R, the sensor 162L being arranged at a position offset to the left of the center line CX (see FIG. 2C) of the foot part 100 in the right-left direction, the sensor 162R being arranged at a position offset to the right of the center line CX. When both the sensor 162L and the sensor 162R detect the reaction force from the walking surface 2, it is possible to identify whether the reaction force from the walking surface 2 is larger on the left side of the second sole member 120 or on the right side thereof.

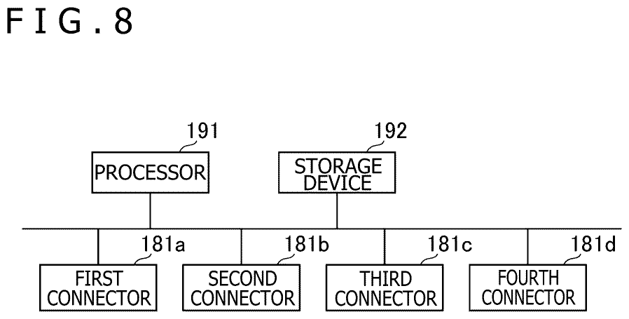

As described above, the foot part 100 may be equipped with the sensor 161L arranged at a position offset to the back left of the foot part 100, the sensor 161R arranged at a position offset to the back right of the foot part 100, the sensor 162L arranged at a position offset to the front left of the foot part 100, and the sensor 162R arranged at a position offset to the front right of the foot part 100. The arrangement makes it possible to determine which of the back left, back right, front left, and front right portions of the foot part 100 receives the largest reaction force. Also, the four sensors 161L, 161R, 162L, and 162R may be arranged at the four vertices of a rectangle (e.g., with its long side extending in the front-back direction). This arrangement facilitates calculation of a gravity center position of the foot part 100 by a processor 191 (see FIG. 8), to be discussed later.

The four sensors 161L, 161R, 162L, and 162R may be fitted with four cables 211L, 211R, 212L, and 212R (see FIG. 2C) for a flexible circuit board or the like, respectively. Further, four connectors 181a through 181d (see FIG. 2C) may be mounted on the circuit board 180. The four connectors 181a through 181d may be connected with terminals of the four cables 211L, 211R, 212L, and 212R, respectively.

As depicted in FIG. 3, the foot part 100 may be equipped with a first strain-generating body 171 attached to the first sole member 110 and to the instep member 130. The first strain-generating body 171 may be a member that generates bending deformation elastically in response to movements of the first sole member 110 with respect to the instep member 130. For example, the first strain-generating body 171 may be a leaf spring that extends in the right-left direction. The first strain-generating body 171 may be arranged interposingly between the first sole member 110 and the instep member 130 in the up-down direction.

As depicted in FIG. 3, the first strain-generating body 171 may include a lower attachment part 171a and an upper attachment part 171b, the lower attachment part 171a being attached to the first sole member 110 by the fixing implements 203 such as screws, the upper attachment part 171b being attached to the instep member 130 by fixing implements 204 such as screws. When attached to the instep member 130 via the first strain-generating body 171, the first sole member 110 can tilt elastically with respect to the instep member 130. For example, there is a case where the first strain-generating body 171 elastically deforms, causing the right part of the first strain-generating body 171 and the right part of the first sole member 110 to be positioned higher relative to the center of the first strain-generating body 171 in the right-left direction and to the first sole member 110. Conversely, there is a case where the left part of the first strain-generating body 171 and the left part of the first sole member 110 are positioned higher relative to the center of the first strain-generating body 171 in the right-left direction and to the first sole member 110.

As depicted in FIG. 3, the first strain-generating body 171 may be equipped with two lower attachment parts 171a and two upper attachment parts 171b, the two lower attachment parts 171a being attached to the first sole member 110 at different positions, the two upper attachment parts 171b being attached to the instep member 130 at different positions. The two lower attachment parts 171a and the two upper attachment parts 171b may be arrayed in the right-left direction. The two upper attachment parts 171b may be arranged interposingly between the two lower attachment parts 171a in the right-left direction. The two lower attachment parts 171a may be positioned closer to the end part of the first strain-generating body 171 than the two upper attachment parts 171b. On the first strain-generating body 171, the two upper attachment parts 171b may be either integrally connected with, or detached from, each other.

The two sensors 161L and 161R included in the first sensor 161 may be strain sensors attached to the first strain-generating body 171. That is, the first sensor 161 may include the strain sensor 161L attached to a position offset to the left of the center line CX (see FIG. 2C) of the foot part 100 in the right-left direction, and the strain sensor 161R attached to a position offset to the right of the center line CX. The processor 191 (see FIG. 8), to be discussed later, may calculate the reaction force from the walking surface 2 at the positions of the strain sensors 161L and 161R on the basis of the output from the strain sensors 161L and 161R (e.g., values representing a magnitude of the strain). This makes it possible to detect the reaction force from the walking surface 2 at both the position offset to the left of the first sole member 110 and the position offset to the right thereof.

As depicted in FIG. 4, the foot part 100 may have a second strain-generating body 172 attached to the second sole member 120 and to the movable member 152. The second strain-generating body 172 may be a member that generates bending deformation elastically in response to movements of the second sole member 120 with respect to the movable member 152. For example, the second strain-generating body 172 may be a leaf spring that extends in the right-left direction. The second strain-generating body 172 may be arranged on the second sole member 120 and on the movable member 152. The second strain-generating body 172 may have a first attachment part 172a and a second attachment part 172b, the first attachment part 172a being attached to the second sole member 120 by fixing implements 205 such as screws, the second attachment part 172b being attached to the movable member 152 by fixing implements 206 such as screws. When attached to the movable member 152 via the second strain-generating body 172, the second sole member 120 can tilt elastically with respect to the movable member 152. For example, there is a case where the second strain-generating body 172 elastically deforms, causing the right part of the second strain-generating body 172 and the right part of the second sole member 120 to be positioned higher relative to the center of the second strain-generating body 172 in the right-left direction and to the second sole member 120. Conversely, there is a case where the left part of the second strain-generating body 172 and the left part of the second sole member 120 are positioned higher relative to the center of the second strain-generating body 172 in the right-left direction and to the second sole member 120.

As depicted in FIG. 4, the second strain-generating body 172 may include two first attachment parts 172a and two second attachment parts 172b, the two first attachment parts 172a being attached to different positions on the second sole member 120, the two second attachment parts 172b being attached to different positions on the movable member 152. The two first attachment parts 172a and the two second attachment parts 172b may be arrayed in the right-left direction. The two first attachment parts 172a may be arranged interposingly between the two second attachment parts 172b in the right-left direction. The two second attachment parts 172b may be positioned closer to the end part of the second strain-generating body 172 than the two first attachment parts 172a. On the second strain-generating body 172, the two first attachment parts 172a may be either integrally connected with, or detached from, each other.

The two sensors 162L and 162R included in the second sensor 162 may also be strain sensors attached to the second strain-generating body 172. The second sensor 162 may include the strain sensor 162L attached to a position offset to the left of the center line CX (see FIG. 2C) of the foot part 100 in the right-left direction, and the strain sensor 162R attached to a position offset to the right of the center line CX. The processor 191 (see FIG. 8), to be discussed later, may calculate the reaction force from the walking surface 2 at the positions of the strain sensors 162L and 162R on the basis of the output from the strain sensors 162L and 162R (e.g., values representing a magnitude of the strain). This makes it possible to detect the reaction force from the walking surface 2 at both the position offset to the left of the second sole member 120 and the position offset to the right thereof.

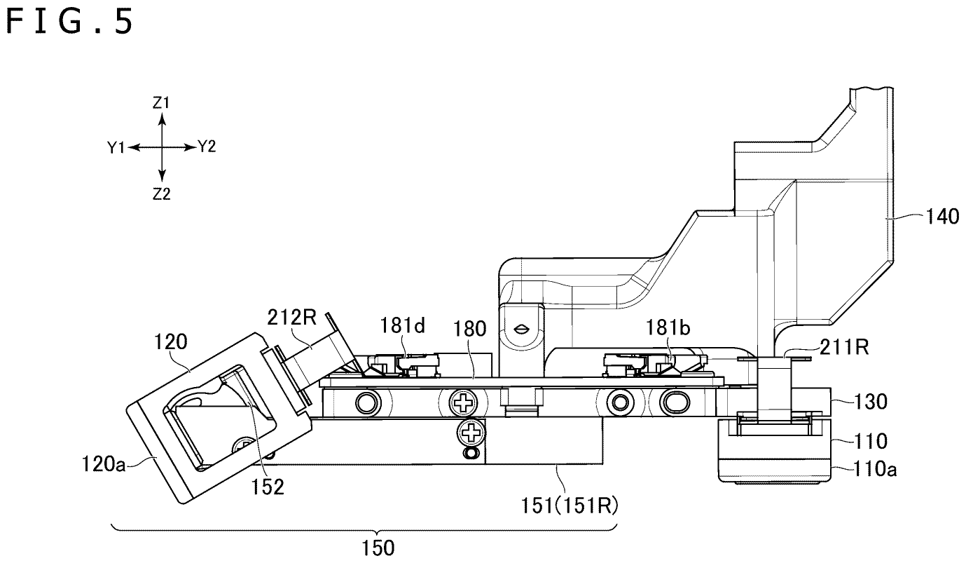

FIG. 5 is a side view that depicts the foot part 100 of the robot 1, indicating a state in which the second sole member 120 has moved from its position in FIG. 2D. The movable member 152 may be configured to rotate relative to the first sole member 110 and to the instep member 130 on an axis line Ax1 (see FIG. 4) along the right-left direction. This allows the second sole member 120 attached to the movable member 152 to rotate relative to the first sole member 110 and to the instep member 130. For example, when the first sole member 110 and the instep member 130 move forward and upward with respect to the second sole member 120 in contact with the walking surface 2, the movable member 152 can rotate relative to the first sole member 110 and to the instep member 130.

As depicted in FIG. 4, the movable member 152 may have a shaft part 152L protruding to the left and a shaft part 152R protruding to the right. These shaft parts 152L and 152R may define the axis line Ax1 which is a center line of rotation for the movable member 152. Further, a bearing 153L may be arranged interposingly between the frame 151 accommodating the movable member 152 on one hand and the shaft part 152L on the other hand. Likewise, a bearing 153R may be arranged interposingly between the frame 151 and the shaft part 152R. This arrangement facilitates the movement of the movable member 152 with respect to the frame 151.

On the movable member 152, the tip of the shaft part 152R protruding to the right or the tip of the shaft part 152L protruding to the left may be equipped with a rotation sensor 154 that detects the degree of rotation of the movable member 152 (e.g., a rotation angle). In the example in FIG. 4, the tip of the shaft part 152R protruding to the right is provided with the rotation sensor 154. The rotation sensor 154 may be equipped with a sensor rotation part 154a attached to the tip of the shaft part 152R, and a sensor fixing part 154b opposed to the sensor rotation part 154a in a direction along the axis line Ax1. The rotation sensor 154 may be a magnetic angle sensor that detects rotations by use of changes in magnetic flux. The sensor rotation part 154a may be a magnet. The sensor fixing part 154b may output a signal reflecting the change in magnetic flux caused by the rotation of the sensor rotation part 154a. The sensor fixing part 154b may be a sensor substrate on which a Hall integrated circuit (IC) is mounted. Alternatively, the sensor rotation part 154a may be a sensor substrate and the sensor fixing part 154b may be a magnet.

As depicted in FIGS. 2D and 5, the second sole member 120 may be configured to move, on the axis line Ax1, between a first posture (see FIG. 2D) in which the bottom of the second sole member 120 (e.g., the anti-slip member 120a) is along the front-back direction and a second posture (see FIG. 5) in which the bottom of the second sole member 120 is tilted with respect to the front-back direction. The first posture may be a state where the bottom of the second sole member 120 is oriented downward, for example. The second posture may be a state where the bottom of the second sole member 120 is oriented forward and diagonally downward, for example.

The joint mechanism 150 may have an elastic member 155 biasing the movable member 152 fitted with the second sole member 120 in such a manner that the second sole member 120 transitions from the second posture in FIG. 5 to the first posture in FIG. 2D. In this manner, the second sole member 120 alone in contact with the walking surface 2 in the second posture can revert to the first posture in which the second sole member 120 is caused to leave the walking surface 2 by the foot part 100 moving upward, for example.

As depicted in FIG. 2B, the elastic member 155 may be a leaf spring that one end thereof (e.g., a back end) is fixed to the back of the foot part 100 and the other end (e.g., a front end) biases the movable member 152 (see FIG. 4). The back end of the elastic member 155 may be fixed to the lower surface of the instep member 130 by one or multiple (four, in the example in FIG. 2B) fixing implement(s) 207 such as a screw (screws). The elastic member 155 may be arranged interposingly between the left frame 151L and the right frame 151R.

When the elastic member 155 biasing the movable member 152 is a leaf spring as described above, the elastic member 155 can be made larger in size than if the movable member 152 is biased by a coil spring, for example. This enables the elastic member 155 to be readily bent elastically, thereby limiting the force that moves the second sole member 120 from the second posture (see FIG. 5) to the first posture (see FIG. 2D). That is, the second sole member 120 contacting the walking surface 2 in the second posture is restrained from reverting to the first posture while still in contact with the walking surface 2.

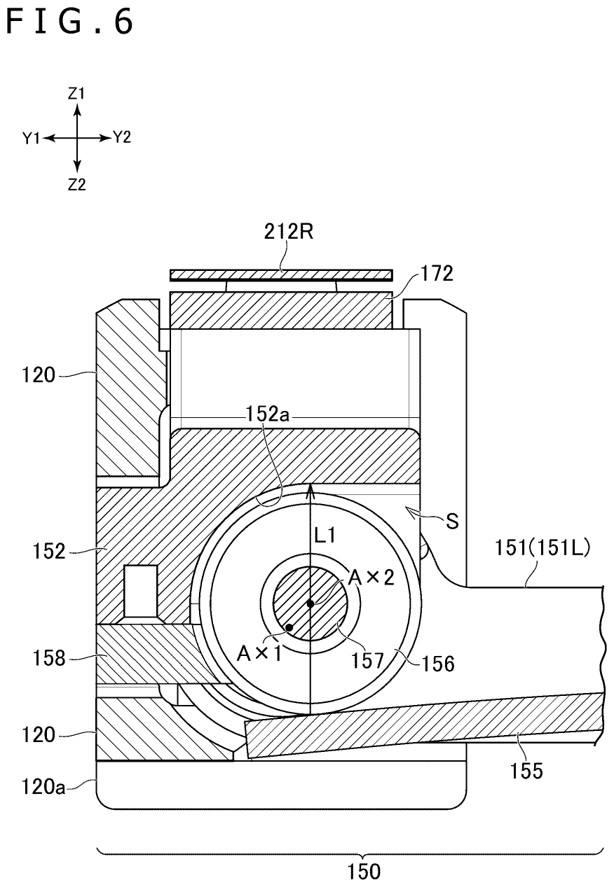

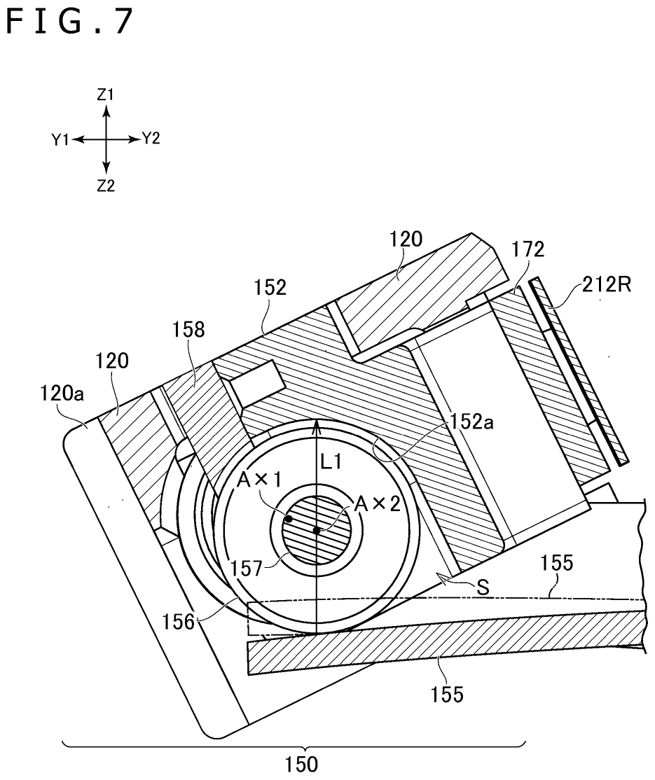

FIG. 6 is a sectional view depicting a cross section of the foot part 100 taken on line VI-VI in FIG. 4. FIG. 7 is a sectional view depicting a cross section of the foot part 100 in a state in which the second sole member 120 is in the second posture (see FIG. 5). The elastic member 155 may push up the movable member 152 from a position offset to the back of the axis line Ax1 which is a center line of rotation of the movable member 152, thereby biasing the second sole member 120 attached to the movable member 152 into the first posture (see FIG. 6).

In FIG. 7, two-dot-dash lines indicate the elastic member 155 with the second sole member 120 in the first posture (see FIG. 6). As depicted in FIG. 7, the amount of deformation of the elastic member 155 with the second sole member 120 in the second posture is greater than with the second sole member 120 in the first posture. In this manner, when the second sole member 120 in the second posture leaves the walking surface 2, the restoring force of the elastic member 155 pushes up the movable member 152, allowing the second sole member 120 attached to the movable member 152 to revert to the first posture.

As depicted in FIGS. 6 and 7, the joint mechanism 150 may be equipped with a pressed member 156 that can move in the up-down direction at a position offset to the back of the axis line Ax1 and is pressed by the elastic member 155. The elastic member 155 may push up the movable member 152 by pressing the pressed member 156 upward (in a direction indicated by an arrow L1 in FIGS. 6 and 7). The elastic member 155 may bias the second sole member 120 into the first posture (see FIG. 6) by pressing the movable member 152 via the pressed member 156. Alternatively, the elastic member 155 may bias the second sole member 120 into the first posture by directly pressing the movable member 152.

As depicted in FIG. 4, the pressed member 156 may be attached to a shaft member 157 extending in the right-left direction at a position offset to the back of the axis line Ax1. A space S may be formed inside the movable member 152. At least a portion of the pressed member 156 and the shaft member 157 may be housed in the space S. Also in the space S inside the movable member 152, a support member 158 supporting the shaft member 157 may be arranged under the shaft member 157. As depicted in FIG. 2B, the movable member 152 and the support member 158 may be exposed at the front of the second sole member 120. The pressed member 156, the shaft member 157, and the support member 158 may each be formed by metal, resin, a rubber material, or an elastomer.

In the space S inside the movable member 152, there may be the pressed member 156 arranged at a position offset to the left of the center line CX (see FIG. 2C) of the foot part 100 in the right-left direction, and the pressed member 156 arranged at a position offset to the right of the center line CX. Note that the number of pressed members 156 arranged in the space S is not limited to two; there may be one pressed member 156, or three or more pressed members 156 arranged in the space S.

As depicted in FIG. 6, the pressed member 156 may be circular in shape. The pressed member 156 may be allowed to rotate around an axis line Ax2 defined by the shaft member 157. This reduces the friction between the pressed member 156 and the elastic member 155 and between the pressed member 156 and the movable member 152. In this manner, the friction between the elastic member 155 and the movable member 152 is made smaller than if the elastic member 155 directly pushes the movable member 152, for example. The movable member 152 is thus prevented from being hampered in a movement by the friction. That is, the second sole member 120 attached to the movable member 152 is allowed to move smoothly, so that the elastic member 155 with its small amount of deformation and limited restoring force can return the second sole member 120 into the first posture (see FIG. 6).

As depicted in FIGS. 6 and 7, an inner edge 152 a of the space S inside the movable member 152 may be formed in an arc-like shape corresponding to the shape of the pressed member 156. Regardless of the posture of the second sole member 120 between the first posture (see FIG. 6) and the second posture (see FIG. 7), the arc-like shape of the inner edge 152a allows the elastic member 155 to push up the second sole member 120 via the pressed member 156. The elastic member 155 may press the pressed member 156 and the second sole member 120 in a direction intersecting the axis line Ax2.

FIG. 8 is a schematic view depicting exemplary electronic components incorporated in the robot 1. As depicted in FIG. 8, the foot part 100 or the robot 1 may be equipped with the processor 191 and a storage device 192 in addition to the connectors 181a through 181d mounted on the circuit board 180. The processor 191 is an electronic component such as a central processing unit (CPU) that performs data processing. The storage device 192 is a memory element such as a read only memory (ROM) or a random access memory (RAM). The storage device 192 may store programs and data including a calculation formula for execution by the processor 191. The processor 191 and the storage device 192 may be mounted either on the circuit board 180 or on a circuit board different from the circuit board 180 (a circuit board

### Attached to the Robot 1).

The processor 191 may calculate the gravity center position of the foot part 100 on the basis of detection results from the four sensors 161L, 161R, 162L, and 162R. In this manner, the processor 191 or another processor (e.g., a processor arranged at a position different from the foot part 100 of the robot 1) can identify the state of the walking surface 2 and also control the actuators 11 through 13, 26, 27, 32 through 35, and 42 through 44 to allow the robot 1 to maintain an appropriate posture with respect to the walking surface 2.

Note that the present disclosure is not limited to the above-described embodiment. For example, with the above embodiment, it is explained that, as depicted in FIGS. 5 and 6, the elastic member 155 pushes up the movable member 152 from a position offset to the back of the axis line Ax1 which is the rotation center line of the movable member 152, thereby biasing the second sole member 120 attached to the movable member 152 into the first posture (see FIG. 5). Alternatively, the elastic member 155 may push down the movable member 152 from a position offset to the front of the axis line Ax1. In this case, the foot part 100 may be equipped with a member fitted with the elastic member 155 at the front of the movable member 152 (e.g., the front of the second sole member 120). This also makes it possible to bias the second sole member 120 attached to the movable member 152 into the first posture.

Further, the number of sensors 161L, 161R, 162L, and 162R attached to the foot part 100 is not limited to four; there may be provided two, three, five, or more sensors. For example, one strain sensor may be mounted on the first strain-generating body 171 attached to the first sole member 110 and to the instep member 130, and another strain sensor may be mounted on the second strain-generating body 172 attached to the second sole member 120 and onto the movable member 152. This also makes it possible to identify whether the reaction force is larger on the front side of the foot part 100 or on the back side thereof.

Moreover, the sensors 161L and 161R included in the first sensor 161 are not limited to the strain sensors attached to the first strain-generating body 171. Alternatively, these sensors may be a pressure sensor attached to either the first sole member 110 or the instep member 130 to measure the pressure from the other member, or an optical distance measuring sensor attached to one of these two members to measure a distance to the other member. Likewise, the sensors 162L and 162R included in the second sensor 162 are not limited to the strain sensors attached to the second strain-generating body 172. These sensors may also be a pressure sensor attached to either the second sole member 120 or the movable member 152 to measure the pressure from the other member, or an optical distance measuring sensor attached to one of these two members to measure a distance to the other member. These arrangements also make it possible for the foot part 100 of the robot 1 appropriately to detect the reaction force from the walking surface 2. (1) As described above, the foot structure described above in the present disclosure may be a foot structure provided on a bottom end of a robot leg part. The foot structure may include a first sole member arranged at a back of the foot structure and contacting a walking surface, a second sole member arranged at a front of the first sole member and contacting the walking surface, a joint mechanism that includes a movable member fitted with the second sole member and configured to move relative to the first sole member, a first sensor arranged on the first sole member to detect reaction force from the walking surface with respect to the first sole member, and a second sensor arranged on the second sole member to detect reaction force from the walking surface with respect to the second sole member. This configuration enhances a degree of freedom of the sole movement and enables appropriate detection of the reaction force from the walking surface. (2) In the foot structure described in (1) above, the second sole member may be configured to tilt relative to the movable member. The second sensor may include a sensor arranged at a position offset to a left of a center line of the foot structure in a right-left direction, and a sensor arranged at a position offset to a right of the center line. This configuration makes it possible to identify whether the reaction force from the walking surface is larger on the left side of the second sole member or on the right side thereof. (3) The foot structure described in (1) or (2) above may further include an instep member connected to the leg part and arranged interposingly between the leg part and the first sole member in an up-down direction. The first sole member may be configured to tilt relative to the instep member. The first sensor may include a sensor arranged at a position offset to a left of a center line of the foot structure in a right-left direction, and a sensor arranged at a position offset to a right of the center line. This configuration makes it possible to identify whether the reaction force from the walking surface is larger on the left side of the first sole member or on the right side thereof. (4) The foot structure described in any one of (1) through (3) above may further include a strain-generating body attached to the movable member and to the second sole member and generating bending deformation in response to a movement of the second sole member with respect to the movable member. The second sensor may include a strain sensor attached to the strain-generating body at a position offset to the left of the center line, and a strain sensor attached to the strain-generating body at a position offset to the right of the center line. (5) The foot structure described in any one of (1) through (4) above may further include a strain-generating body attached to the instep member and to the first sole member and generating bending deformation in response to a movement of the first sole member with respect to the instep member. The first sensor may include a strain sensor attached to the strain-generating body at a position offset to the left of the center line, and a strain sensor attached to the strain-generating body at a position offset to the right of the center line. (6) In the foot structure described in any one of (1) through (5) above, the movable member may be configured to rotate relative to the first sole member on an axis line along a right-left direction. This configuration enables the second sole member attached to the movable member to rotate relative to the first sole member. (7) In the foot structure described in (6) above, the second sole member may be configured to move, on the axis line, between a first posture in which a base end surface of the second sole member is in a front-back direction and a second posture in which the base end surface of the second sole member is inclined relative to the front-back direction. The joint mechanism may further include an elastic member that biases the movable member fitted with the second sole member in such a manner that a posture of the second sole member transitions from the second posture to the first posture. In this configuration, the second sole member alone in contact with the walking surface can revert from the current second posture to the first posture when the second sole member leaves the walking surface. (8) In the foot structure described in (7) above, the elastic member may be a leaf spring that one end thereof is fixed to the back of the foot structure and another end biases the movable member. This configuration allows the elastic member to be readily bent elastically, thereby limiting the force that moves the second sole member from the second posture to the first posture. This prevents the second sole member in the second posture while in contact with the walking surface from reverting to the first posture while still in contact with the walking surface. (9) In the foot structure described in (7) or (8) above, the elastic member may bias the second sole member into the first posture by pushing the movable member upward or downward from a position offset to a front or a back of the axis line. (10) In the foot structure described in (9) above, the joint mechanism may further include a pressed member configured to move in an up-down direction at a position offset in the front-back direction from the axis line. The elastic member may bias the second sole member into the first posture by pressing the movable member via the pressed member. (11) In the foot structure described in any one of (1) through (10) above, the first sensor may include a sensor arranged at a position offset to a left of a center line of the foot structure in a right-left direction, and a sensor arranged at a position offset to a right of the center line. The second sensor may include a sensor arranged at a position offset to the left of the center line, and a sensor arranged at a position offset to the right of the center line. The foot structure may further include a processor that calculates a gravity center position of the foot structure, based on detection results from the first sensor and the second sensor. This configuration makes it possible to calculate the gravity center position of the foot structure. (12) Further, the robot described in the present disclosure may be a robot having a leg part and a foot structure provided on a bottom end of the leg part. The robot may include a first sole member arranged at a back of the foot structure and contacting a walking surface, a second sole member arranged at a front of the first sole member and contacting the walking surface, a joint mechanism that includes a movable member fitted with the second sole member and configured to move relative to the first sole member, a first sensor arranged on the first sole member to detect reaction force from the walking surface with respect to the first sole member, and a second sensor arranged on the second sole member to detect reaction force from the walking surface with respect to the second sole member. This configuration enhances the degree of freedom of the sole movement and enables appropriate detection of the reaction force from the walking surface.

What is claimed is:

1. A foot structure provided on a bottom end of a robot leg part, the foot structure comprising:
a first sole member arranged at a back of the foot structure and configured to contact a walking surface;
a second sole member arranged at a front of the first sole member and configured to contact the walking surface;
a joint mechanism that includes a movable member fitted with the second sole member and configured to move relative to the first sole member;
a first sensor arranged on the first sole member and configured to detect reaction force from the walking surface with respect to the first sole member; and
a second sensor arranged on the second sole member and configured to detect reaction force from the walking surface with respect to the second sole member.

2. The foot structure according to claim 1, wherein
the second sole member is configured to tilt relative to the movable member, and
wherein the second sensor includes:
a third sensor arranged at a position offset to a left side of a center line of the foot structure in a right-left direction; and
a fourth sensor arranged at a position offset to a right side of the center line.

3. The foot structure according to claim 1, further comprising:
an instep member connected to the leg part and arranged interposingly between the leg part and the first sole member in an up-down direction, wherein
the first sole member is configured to tilt relative to the instep member, and
the first sensor includes:
a third sensor arranged at a position offset to a left side of a center line of the foot structure in a right-left direction; and
a fourth sensor arranged at a position offset to a right side of the center line.

4. The foot structure according to claim 1, further comprising:
a strain-generating body attached to the movable member and to the second sole member and configured to generate bending deformation in response to a movement of the second sole member with respect to the movable member,
wherein the second sensor includes:
a first strain sensor attached to the strain-generating body at a position offset to a left side of a center line; and
a second strain sensor attached to the strain-generating body at a position offset to a right side of the center line.

5. The foot structure according to claim 1, further comprising:
a strain-generating body attached to an instep member and to the first sole member, and configured to generate bending deformation in response to a movement of the first sole member with respect to the instep member,
wherein the first sensor includes:
a first strain sensor attached to the strain-generating body at a position offset to a left side of a center line; and
a second strain sensor attached to the strain-generating body at a position offset to a right side of the center line.

6. The foot structure according to claim 1, wherein the movable member is configured to rotate relative to the first sole member on an axis along a right-left direction.

7. The foot structure according to claim 6, further comprising a rotation sensor configured to detect a degree of rotation of the movable member around the axis,
wherein the rotation sensor is a magnetic angle sensor comprising a sensor rotating part defined by a magnet attached to a tip of a shaft part of the movable member, and a sensor fixing part defined by a sensor board comprising a Hall integrated circuit (IC) that faces the magnet along a direction of the axis.

8. The foot structure according to claim 6, wherein
the second sole member is configured to move, on the axis, between a first posture wherein a bottom surface of the second sole member is in a front-back direction and a second posture wherein the bottom surface of the second sole member is inclined relative to the front-back direction, and
the joint mechanism further includes an elastic member configured to move the second sole member from the second posture to the first posture by biasing the movable member fitted with the second sole member.

9. The foot structure according to claim 8, wherein the elastic member is a leaf spring comprising:
one end fixed to the back of the foot structure; and
another end configured to bias the movable member.

10. The foot structure according to claim 8, wherein the elastic member is configured to bias the second sole member into the first posture by pushing the movable member upward or downward from a position offset to a front or a back of the axis.

11. The foot structure according to claim 10, wherein
the joint mechanism further includes a pressed member configured to move in an up-down direction at a position offset in the front-back direction from the axis, and
the elastic member is configured to bias the second sole member into the first posture by pressing the movable member via the pressed member.

12. The foot structure according to claim 11, wherein
the pressed member is annular and configured to rotate around a second axis defined by a shaft member shifted backward from the axis, the pressed member configured to reduce friction generated between the pressed member and the elastic member, and friction generated between the pressed member and the movable member during relative movement.

13. The foot structure according to claim 11, wherein
an inner edge of an internal space formed within the movable member is formed in an arc shape that corresponds to an outer circular profile of the pressed member, wherein the elastic member continuously biases the second sole member via the pressed member across an entire range of motion between the first posture and the second posture.

14. The foot structure according to claim 1, wherein
the first sensor includes:
a third sensor arranged at a position offset to a left side of a center line of the foot structure in a right-left direction; and
a fourth sensor arranged at a position offset to a right side of the center line,
wherein the second sensor includes:
a fifth sensor arranged at a position offset to the left side of the center line; and
a sixth sensor arranged at a position offset to the right side of the center line, and
wherein the foot structure further includes a processor communicably coupled to the first sensor and the second sensor, and configured to calculate a gravity center position of the foot structure, based on detection results from the first sensor and the second sensor.

15. The foot structure according to claim 14, wherein the third sensor, the fourth sensor, the fifth sensor, and the sixth sensor are arranged at respective vertices of a rectangle having long sides extending in a front-rear direction of the foot structure to facilitate calculation of the gravity center position.

16. A robot comprising:
at least one leg part;
a foot structure provided on a bottom end of the at least one leg part;
a first sole member arranged at a back of the foot structure and contacting a walking surface;
a second sole member arranged at a front of the first sole member and contacting the walking surface;
a joint mechanism that includes a movable member fitted with the second sole member and configured to move relative to the first sole member;
a first sensor arranged on the first sole member to detect reaction force from the walking surface with respect to the first sole member; and
a second sensor arranged on the second sole member to detect reaction force from the walking surface with respect to the second sole member.

17. The robot according to claim 16, further comprising:
a plurality of actuators configured to move the at least one leg part; and
a processor communicatively coupled to the plurality of actuators and configured to execute instructions to dynamically control the plurality of actuators based on a calculated state of the walking surface and a gravity center position to maintain an appropriate posture of the robot relative to the walking surface.

18. The robot according to claim 16, wherein the at least one leg part comprises an ankle joint comprising:
a first ankle actuator connected to the foot structure and configured to rotate the foot structure around an X-axis direction to adjust a roll angle of the foot structure; and
a second ankle actuator connected to the foot structure and configured to rotate the foot structure around a Y-axis direction to adjust a pitch angle of the foot structure.

19. The robot according to claim 16, further comprising:
a hip part connected to the at least one leg part;
a chest part; and
a waist joint connecting the chest part to the hip part, the waist joint comprising a plurality of waist actuators configured to rotate the chest part relative to the hip part across three axes of roll, pitch, and yaw based on the reaction forces detected by the first sensor and the second sensor.

20. The robot according to claim 16, wherein the at least one leg part comprises at least one of a right front leg part, a left front leg part, a right rear leg part, or a left rear leg part, each having the foot structure provided on its respective bottom end.
